(19) United States
(12) Patent Application Publication
(10) Pub. No.: US 2006/0287868 A1
(43) Pub. Date: Dec. 21, 2006

(54) Dialog system

(75) Inventors: Takuro Ikeda, Kanagawa (JP); Eiji Kitagawa, Kanagawa (JP); Toshiyuki Fukuoka, Kanagawa (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: FUJITSU LIMITED, Kanagawa (JP)

(21) Appl. No.: 11/244,071

(22) Filed: Oct. 6, 2005

(30) Foreign Application Priority Data
Jun. 15, 2005 (JP) 2005-175570

(51) Int. Cl. G10L 21/00

(52) U.S. Cl. 704/275

(57) ABSTRACT

A dialog system is provided that enables appropriate processing of reinput by a user without describing a dialog scenario on the assumption of reinput by the user. The dialog system includes a reinput acceptable state storage unit that stores a state prior to transition and a reinput recognition candidates set storage unit that stores a recognition candidates set assigned to the state prior to the transition. At the time of a user's input, both of the recognition candidates set associated with that state and the recognition candidates set stored in the reinput recognition candidates set storage unit are referred to so as to determine a recognition candidate. In the case where the determined recognition candidate is a recognition candidate described in the recognition candidates set stored in the reinput recognition candidates set storage unit, the state stored in the reinput acceptable state storage unit is determined as the state to be changed.

### BACKGROUND OF THE INVENTION

1. Field of the Invention

The present invention relates to a dialog system that enables state transition in accordance with a response by a user to a question from a system. More particularly, the present invention relates to a dialog system that can accept reinput for a past state.

2. Description of Related Art

As a conventionally known dialog system, there is a dialog system that realizes a dialog between a user and a system by utilizing a voice recognition module for example as means for accepting an input from the user. Such a dialog system has been used for an information providing system such as a voice portal, an interactive voice response (IVR) system for call center service, a car navigation system and the like.

In a conventional dialog system, a dialog between a system and a user is realized by processing a dialog scenario containing the description of the progress of the dialog. In general, the dialog scenario is expressed by a state transition model. Contents of a system output and a set of recognition candidates are assigned to each state, where a vocabulary that the system recognizes from a user input is described in the recognition candidates set. Depending on a recognition result of a user input in response to the system output, the state to be changed next is determined. By repeating this procedure, the dialog progresses. The dialog scenario is written in a language such as VoiceXML. The recognition candidates set is written in a language such as Speech Recognition Grammar Specification (SRGS).

In order to accept an input from a user, a voice recognition technology is used. This technology is to convert a voice input from the user to text information with a voice recognition module (this may be also called an Automatic Speech Recognition (ASR) module). The voice recognition module refers to a designated recognition candidates set, and if it is estimated that the user input matches any one of the recognition candidates included in the recognition candidates set, then the voice recognition module returns it as a recognition result. The voice recognition module has a function of returning a likelihood for the agreement of the recognition result with the actual user input as a reliability, as well as the recognition result. Also, the voice recognition module can refer to a plurality of recognition candidates sets at the same time to carry out the recognition.

In order to present information from the system, a voice synthesis technology is used. With this technology, a voice synthesis module (this may be also called a Text To Speech (TTS) module) can read aloud text information automatically. Users can access the service by using an input device and an output device directly connected with the dialog system or by accessing the dialog system via network using a fixed-line phone, a mobile communication device such as a cellphone and a PDA, a car navigation and the like.

In the dialog system, a user often reinputs information in order to change or correct the already-input information. Particularly, in a voice dialog system, after a user responds to a question from the system, the user often reinputs information because of recognition errors by the system, speech errors and hesitation in speech, etc., by the user. In order to facilitate such reinputting, there is proposed a voice recognition apparatus that enables easy correction of the input simply by speaking again without the requirement for key operation for confirming and correcting a recognition result, when a series of speech is to be input for plural different items (see JP H05-66794 A).

### SUMMARY OF THE INVENTION

However, in the conventional dialog system, a recognition candidates set that gives valid user's responses to various questions from system and processes to be conducted when a user's input matches one of the recognition candidates included in the recognition candidates set have to be all described in the dialog scenario. Therefore, in order to realize a dialog system enabling reinputting, a recognition candidates set for accepting reinput for the former question has to be made valid even when the system gives the next question, and moreover the process to be conducted when the reinputting is carried out actually has to be described explicitly in the dialog scenario.

Especially in the case where the order of the questions from the system is not determined beforehand but the flow of the dialog will be determined in accordance with a situation such as the contents of the input by a user, the description in the dialog scenario becomes extremely complicated, which means an increase in development cost. This is because the recognition candidates set for accepting reinput should be designed by referring to the history of the dialog as to what the former question is. Further, with consideration given to the flows of all possible dialogs, a process to be conducted when reinputting is carried out should be described in the dialog scenario.

Therefore, with the foregoing in mind, it is an object of the present invention to provide a dialog system that enables appropriate processing of reinput by a user without describing a dialog scenario on the assumption of reinput by the user.

A “dialog” between the dialog system of the present invention and a user is not limited to a dialog by means of voice. For instance, information exchange by means of text data or the like that a user inputs using an input device such as a key board, a handwritten characters inputting apparatus or the like also is included in the concept of the “dialog” of the present invention.

In order to fulfill the above-stated object, a dialog system of the present invention includes: an input unit that accepts an input by a user; an output unit that presents information to the user; a dialog scenario storage unit that stores a dialog scenario with a state transition model described therein that is in accordance with a dialog with the user performed through the input unit and the output unit; a state management unit that, based on the state transition model described in the dialog scenario, determines a state to be changed next among states included in the state transition model in accordance with the input by the user through the input unit; a current state storage unit that stores a current state among the states included in the state transition model; a process execution unit that executes a process assigned to the state determined by the state management unit; a recognition candidates set storage unit that stores beforehand recognition candidates sets including recognition candidates for user's inputs that are assumed with respect to each of states included in the state transition model, each of the recognition candidates sets being associated with each of the states included in the state transition model; a reinput acceptable state storage unit that, at the time of transition to a next state, stores a state prior to the transition; a reinput recognition candidates set storage unit that, at the time of the transition to the next state, stores a recognition candidates set assigned to the state prior to the transition; and a recognition processing unit that, at the time of a user's input, refers to both of the recognition candidates set associated with a state at the time of the user's input and the recognition candidates set stored in the reinput recognition candidates set storage unit so as to determine a recognition candidate corresponding to the user's input. In the case where the recognition candidate determined by the recognition processing unit is a recognition candidate described in the recognition candidates set stored in the reinput recognition candidates set storage unit, the state management unit determines that the state stored in the reinput acceptable state storage unit is the state to be changed.

With this configuration, at the time of the transition from some state to the next state, the state prior to the transition is stored in the reinput acceptable state storage unit and a recognition candidates set assigned to the state prior to the transition is stored in the reinput recognition candidates set storage unit. Then, at the time of a user's input, the recognition processing unit refers to both of the recognition candidates set associated with a state at the time of the user's input and the recognition candidates set stored in the reinput recognition candidates set storage unit so as to determine a recognition candidate corresponding to the user's input. In the case where the thus determined recognition candidate is a recognition candidate described in the recognition candidates set stored in the reinput recognition candidates set storage unit, the state management unit determines that the state stored in the reinput acceptable state storage unit is the state to be changed. Thereby, a dialog system can be provided that enables the acceptance of reinput for the former state and appropriate processing of the same without describing a dialog scenario on the assumption of reinput by the user as in the conventional system.

Preferably, the dialog system of the present invention further includes a reinput judgment unit. At the time of a user's input, in the case where both of the recognition candidates set associated with the state stored in the current state storage unit and the recognition candidates set stored in the reinput recognition candidates set storage unit include a recognition candidate corresponding to the user's input, the reinput judgment unit determines a priority order of these recognition candidates sets based on a predetermined criterion.

With this configuration, in the case where the user's input corresponds to both of a recognition candidate for reinput for the former state and a recognition candidate for input for the current state, the reinput judgment unit can determine the user's input should be handled as the input for either one. Herein, in such a case, the priorities of these recognition candidates sets may be set for each dialog system, depending on the purpose of the system or the like.

Preferably, the dialog system of the present invention further includes a reinput recognition candidates set conversion unit that converts the recognition candidates set stored in the reinput recognition candidates set storage unit to a recognition candidates set including recognition candidates that are assumed to be used when the user performs reinput. With this configuration, the recognition candidates set stored in the reinput recognition candidates set storage unit is converted to a recognition candidates set including recognition candidates that are assumed to be used often by a user when the user performs reinput. Thereby, reinput by a user can be recognized more accurately.

In the above-stated case, the recognition processing unit may further store a result of preceding recognition, and the reinput recognition candidates set conversion unit may remove the result of the preceding recognition from the recognition candidates set stored in the reinput recognition candidates set storage unit. Since reinput by a user may be caused by a recognition error of the preceding recognition, by removing the result of the preceding recognition from the recognition candidates set, the recognition accuracy during the reinputting can be enhanced.

Alternatively, in the above-stated case, the reinput recognition candidates set conversion unit may add to the recognition candidates set stored in the reinput recognition candidates set storage unit, new recognition candidates obtained by adding vocabulary items that are used by the user during reinput to any one of recognition candidates described in the recognition candidates set. In the case of reinputting, especially in the case of correcting himself/herself by voice inputting, a user often adds vocabulary items for denying the former input (e.g., interjections). Therefore, by preparing new recognition candidates so as to additionally include such vocabulary items at before and/or after the recognition candidates and by adding the new recognition candidates to the recognition candidates set, the recognition accuracy during the reinputting can be enhanced.

In the dialog system of the present invention, preferably, in the case where some state is changed to a next state without any inputs from the user, it is preferable that the state stored in the reinput acceptable state storage unit and the recognition candidates set stored in the reinput recognition candidates set storage unit are not updated. With this configuration, in the state where there is no input from a user, the erroneous acceptance of reinput can be prevented.

Preferably, the dialog system of the present invention further includes a reinput result verification state generation unit. In the case where an input by the user matches a recognition candidate included in the recognition candidates set stored in the reinput recognition candidates set storage unit, the reinput result verification state generation unit generates a state for explicitly verifying with the user a recognition result of the recognition processing unit. With this configuration, after the user can verify the recognition result for reinputting, the state can be changed to the next state.

In the dialog system of the present invention, preferably, in the case where an input by the user matches a recognition candidate included in the recognition candidates set stored in the reinput recognition candidates set storage unit, a procedure is called that is for restoring a result of a procedure by an application program called at a state of the input by the user to an original state. With this configuration, the result of the procedure that is started by a recognition error, for example, can be restored to an original state.

In the dialog system of the present invention, preferably, the reinput acceptable state storage unit includes a region for storing a plurality of past states, and the reinput recognition candidates set storage unit includes a region for storing recognition candidates sets assigned to the past states. Preferably, the dialog system further includes a recognition result history storage unit that stores a recognition result obtained in response to a user's input to a past state. With this configuration, reinputting for a two or more preceding state also can be accepted and processed appropriately.

Further, a program recording medium of the present invention has a program thereon that makes a computer execute a dialog process with a user. The computer is provided with an input unit accepting an input by the user and an output unit presenting information to the user. The program makes the computer execute the steps of a process execution step of referring to a dialog scenario with a state transition model described therein that is in accordance with a dialog with the user performed through the input unit and the output unit, determining, based on the state transition model, a state to be changed next among states included in the state transition model in accordance with the input by the user through the input unit, and storing the determined state in a current state storage unit and executing a process assigned to the determined state; a storage step of, at the time of transition to a next state, storing a state prior to the transition in a reinput acceptable state storage unit and storing a recognition candidates set assigned to the state prior to the transition in a reinput recognition candidates set storage unit; and a recognition step of, at the time of a user's input, referring to a recognition candidates set storage unit that stores beforehand recognition candidates sets including recognition candidates for user's inputs that are assumed with respect to each of states included in the state transition model, each of the recognition candidates sets being associated with each of the states included in the state transition model, and referring to both of the recognition candidates set associated with a state at the time of the user's input and the recognition candidates set stored in the reinput recognition candidates set storage unit so as to determine a recognition candidate corresponding to the user's input. In the case where the recognition candidate determined at the recognition step is a recognition candidate described in the recognition candidates set stored in the reinput recognition candidates set storage unit, in the subsequent process execution step, the program makes the computer determine that the state stored in the reinput acceptable state storage unit is the state to be changed.

According to the present invention, a dialog system can be provided that enables appropriate processing of reinput by a user without describing a dialog scenario on the assumption of reinput by the user in the dialog.

### BRIEF DESCRIPTION OF THE DRAWINGS

FIG. 1 is a block diagram of a dialog system according to Embodiment 1 of the present invention.

FIG. 2 is a block diagram of a dialog system according to Embodiment 2 of the present invention.

FIG. 3 shows a dialog example in the dialog system according to Embodiment 2.

FIG. 4 shows a state transition model in the dialog system according to Embodiment 2.

FIG. 5 shows one example of a conventional dialog scenario.

FIG. 6 shows an example of a scenario in the dialog system according to Embodiment 2.

FIG. 7 is a flowchart showing an operation example of the dialog system according to Embodiment 2.

FIG. 8 is a block diagram of a dialog system according to Embodiment 3 of the present invention.

FIG. 9 shows a dialog example in the dialog system according to Embodiment 3.

FIG. 10 shows a state transition model in the dialog system according to Embodiment 3.

FIG. 11 is a flowchart showing an operation example of the dialog system according to Embodiment 3.

FIG. 12 is a block diagram of a dialog system according to Embodiment 4 of the present invention.

FIG. 13 shows a state transition model in the dialog system according to Embodiment 4.

FIG. 14 is a block diagram of an improved example of a dialog system according to Embodiment 4.

FIG. 15 shows schematically one example of the contents stored in a recognition result history storage unit of FIG. 14.

### DETAILED DESCRIPTION OF THE INVENTION

### Embodiment 1

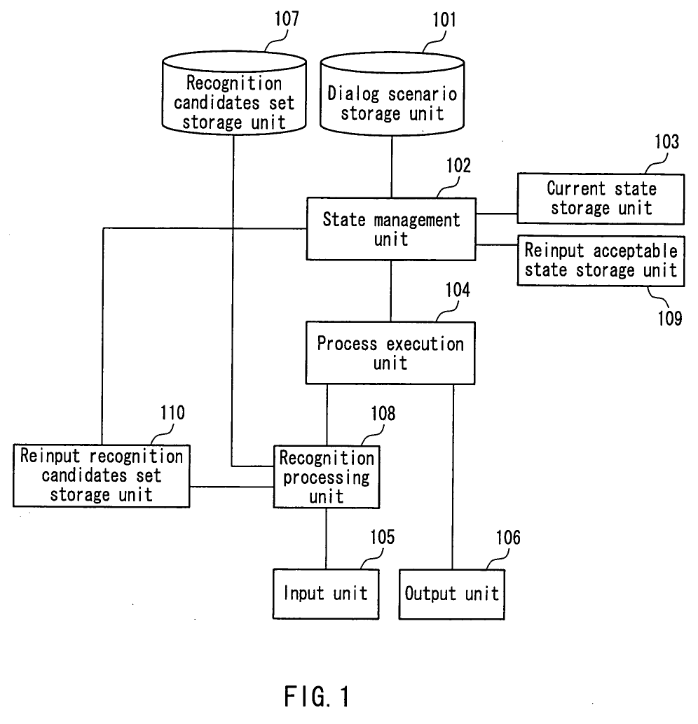

Hereinafter, fundamental embodiments of a dialog system of the present invention will be described. FIG. 1 is a block diagram schematically showing the configuration of a dialog system according to this embodiment.

As shown in FIG. 1, the dialog system of the present embodiment includes: a dialog scenario storage unit 101; a state management unit 102, a current state storage unit 103; a process execution unit 104; an input unit 105; an output unit 106; a recognition candidates set storage unit 107; a recognition processing unit 108; a reinput acceptable state storage unit 109; and a unit 110 for storing a recognition candidates set for reinput (hereinafter called “reinput recognition candidates set storage unit 110”).

This dialog system is configured with a computer, and the state management unit 102, the process execution unit 104 and the recognition processing unit 108 are functional blocks that are implemented by making a processor of the computer execute predetermined programs. That is, these units may not be always provided as the corresponding hardware. The dialog scenario storage unit 101, the current state storage unit 103, the recognition candidates set storage unit 107, the reinput acceptable state storage unit 109 and the reinput recognition candidates set storage unit 110 are implemented by an internal storage unit in the computer or an external storage unit to which the computer can access.

The input unit 105 has a function of accepting a user's input, which can be implemented by an input device such as a microphone in the case of a voice-inputting dialog system and by an input device such as a keyboard, a ten key or a tablet in the case of a text data or numerical data inputting dialog system. In the case of the voice inputting, the input unit 105 or the recognition processing unit 108 has a voice recognition function for recognizing the contents of the speech by a user. In the case where a user inputs text data or the like with handwritten characters, the input unit 105 or the recognition processing unit 108 has a character recognition function for recognizing characters, signs and the like from the handwriting by the user. Since the mechanism for realizing the voice recognition function and the character recognition function are known, the detailed explanations therefor are omitted. The output unit 106 has a function of presenting an output from the system to a user, which can be implemented by a speaker, a display or the like.

The dialog scenario storage unit 101 stores a dialog scenario for realizing a dialog between the system and a user. The dialog scenario is described based on a state transition model. Each state includes a process assigned thereto, which is to be executed in that state. Specifically, the following are described as the process assigned to each state: (1) contents of a system output (e.g., a question from the system to a user); (2) a recognition candidates set in which a recognition candidate for a user's input is described, and a state to be changed next hereinafter called a “next transition state”) in the case of a user's input matching any one of the recognition candidates included in the recognition candidates set or in the case of a failure in correct recognition of a user's input or in the case of no input from user, which are described for each state in the dialog scenario. The specific examples of the dialog scenario will be described later. The state management unit 102 determines the next transition state and the process execution unit 104 executes the process assigned to the state determined by the state management unit 102, whereby a dialog between the system and the user can be realized.

When the state management unit 102 determines the next transition state, the current state storage unit 103 stores the name of that state. The process execution unit 104 refers to the dialog scenario in the dialog scenario storage unit 101 and controls the recognition processing unit 108 and the output unit 106 based on the contents of the system output and the recognition candidates set assigned to the state determined by the state management unit 102. The recognition candidates set storage unit 107 stores beforehand sets of vocabulary that is expected to be input by a user as recognition candidates sets, each recognition candidates set being associated with each state of the state transition model described in the dialog scenario. In other words, the number of the recognition candidates sets stored in the recognition candidates set storage unit 107 is the same as the number of the states included in the state transition model that accept some input from a user. The recognition processing unit 108 refers to the recognition candidates set that is designated as that corresponding to the current state among the recognition candidates sets stored in the recognition candidates set storage unit 107. The recognition processing unit 108 conducts a recognition process of the user's input from the input unit 105. If the recognition processing unit 108 estimates that the user's input matches any one of the recognition candidates included in the recognition candidates set, the recognition processing unit 108 passes that one as the recognition result to the state management unit 102. The state management unit 102 determines the next transition state based on the current state stored in the current state storage unit 103 and the recognition result by the recognition processing unit 108. In the dialog system of the present embodiment, the dialog progresses by repeating the above-stated series of processes.

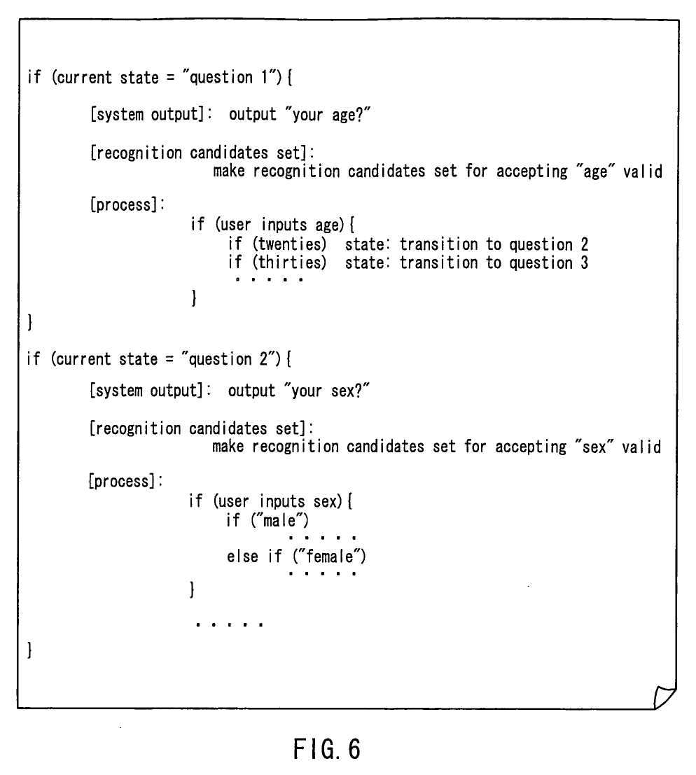

Further, in the dialog system of the present embodiment, the reinput acceptable state storage unit 109 stores the name of the state prior to the transition to the current state. Herein, in the present embodiment, names such as “question 1” and “question 2” are assigned to the respective states (see FIG. 4 and FIG. 6), and these names are stored in the current state storage unit 103 and the reinput acceptable state storage unit 109. However, identifiers for identifying the respective states are not limited to such names, and any identifier may be used. The reinput recognition candidates set storage unit 110 stores the recognition candidates set that is assigned to the state prior to the transition to the current state. In this way, according to the dialog system of the present embodiment, when state transition is carried out, the name of the state prior to the transition is stored in the reinput acceptable state storage unit 109, and the recognition candidates set assigned to the state prior to the transition is stored in the reinput recognition candidates set storage unit 110.

Then, when the process assigned to the state after the transition is carried out, a user's input will be followed by referring to the recognition candidates set assigned to the state prior to the transition that is stored in the reinput recognition candidates set storage unit 110 concurrently with the reference to the recognition candidates set assigned to the state after the transition. Whether or not to check the recognition candidates set assigned to the state after the transition firstly or check the recognition candidates set assigned to the state prior to the transition stored in the reinput recognition candidates set storage unit 110 firstly, or whether or not to check the combination of the both recognition candidates sets may depend on the design of the system. In the case where the dialog containing the same options for response is continued, the system preferably is designed so as to prioritize either one based on the dialog contents.

In the case where the user performs reinput corresponding to the state prior to the transition, the vocabulary item that the users reinputs will match one of the recognition candidates included in the recognition candidates set assigned to the state prior to the transition that is stored in the reinput recognition candidates set storage unit 110. In this case, the contents of the current state storage unit 103 are temporarily returned to the state prior to the transition that is stored in the reinput acceptable state storage unit 109, and then transition to the state determined based on the recognition result of the user's input is performed. Thereby, the dialog can be continued in a similar manner to the case where the user's input is performed in the state prior to the transition.

As stated above, in the dialog system of the present embodiment, there is no need to describe the dialog scenario on the assumption of reinput by a user. Instead, by referring to the recognition candidates set assigned to the former state concurrently with the recognition candidates set assigned to the current state, the reinput by the user can be accepted.

### Embodiment 2

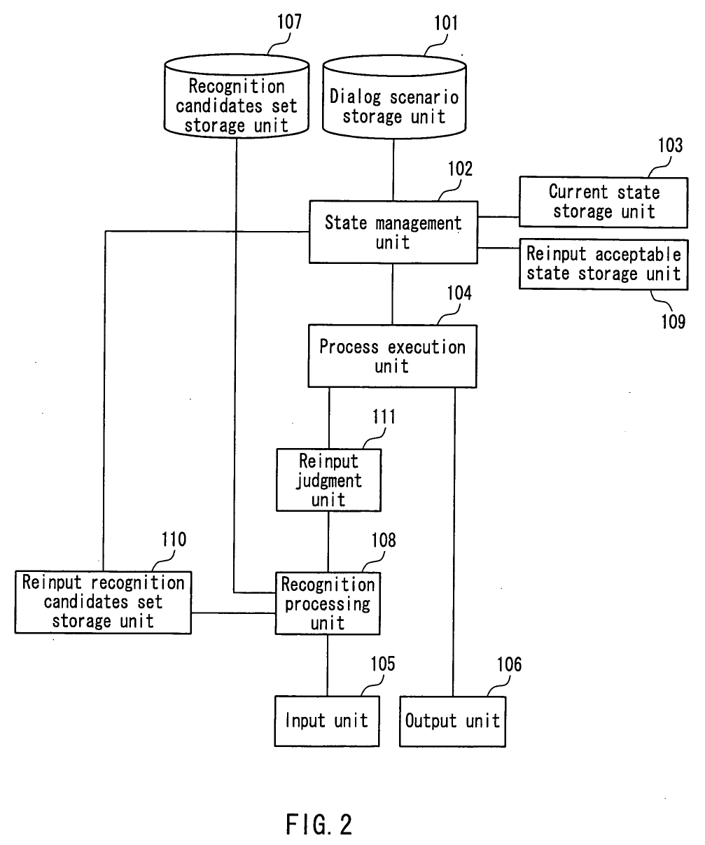

The following describes another embodiment of a dialog system according to the present invention. FIG. 2 is a block diagram schematically showing the configuration of a dialog system according to the present embodiment. Note here that the same reference numerals are assigned to the elements having the same functions as those in the configuration described in Embodiment 1, and their detailed explanations are omitted.

As shown in FIG. 2, the dialog system of the present embodiment further includes a reinput judgment unit 111, in addition to the configuration of the dialog system of Embodiment 1. The reinput judgment unit 111 has a function of, when recognition results are obtained from both of the recognition candidates set assigned to the current state and the recognition candidates set assigned to the former state, determining which one of the recognition results is to be prioritized.

In the case where recognition results are obtained from both of the recognition candidates set assigned to the current state and the recognition candidates set assigned to the former state, the priorities of these recognition candidates sets may be determined by comparing their reliabilities that are returned with the recognition results. Alternatively, some weights may be assigned to the recognition candidates set assigned to the current state and the recognition candidates set assigned to the former state, and then the priorities of these recognition candidates sets may be determined. If a user's input matches any one of the recognition candidates that is commonly included in the recognition candidates set assigned to the current state and the recognition candidates set assigned to the former state, the reinput judgment unit 111 determines the priorities of these recognition candidates sets. Normally, it may be considered more natural to put a higher priority on the recognition candidates set assigned to the current state. However, the priorities can be set freely depending on the purpose of the dialog system and the like.

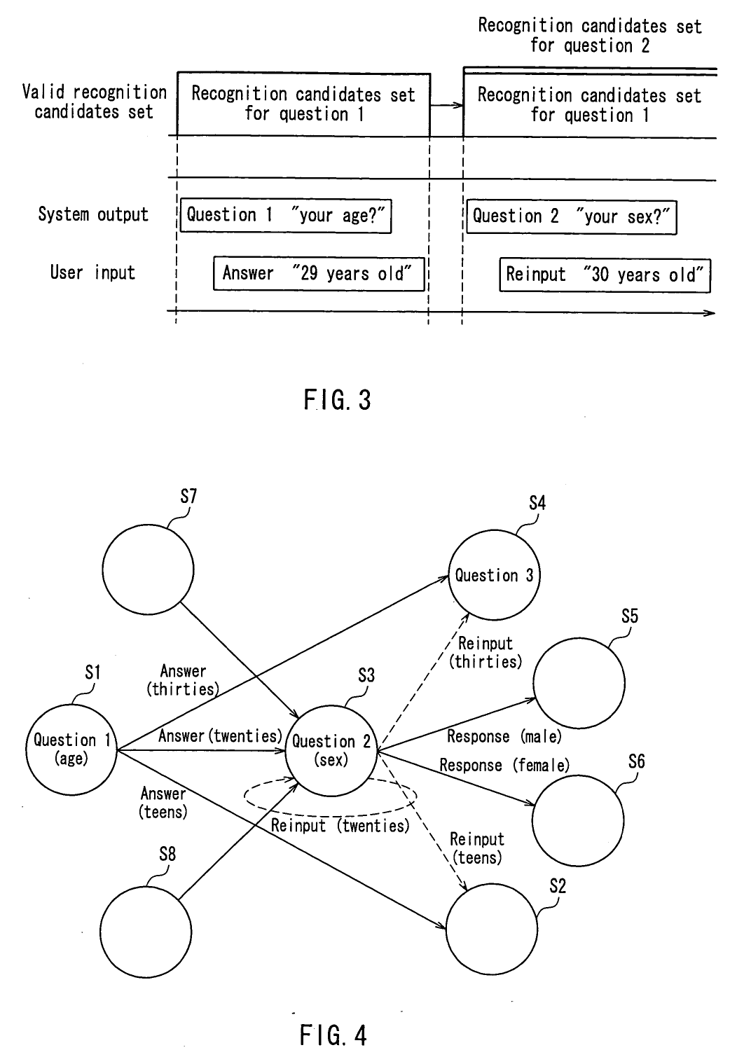

The following is an explanation of a specific example of the processes in the dialog system according to the present embodiment. In the following, a dialog scenario is assumed in which the dialog system asks a user his/her age and sex one by one to complete user registration. FIG. 3 shows a dialog example where the user firstly answers “twenty-nine years old” in response to the question of age from the dialog system (question 1), and then while the dialog system asks about sex (question 2), the user reinputs an answer of “thirty years old” with respect to the former question 1. As shown in FIG. 3, in the dialog system according to the present embodiment, while the dialog system asks the question 2, both of the recognition candidates set for question 1 and the recognition candidates set for question 2 are made valid. Herein, a “valid” recognition candidates set means that the recognition candidates set can be referred to by the recognition processing unit 108 and can be used for the recognition process.

FIG. 4 shows one example of the state transition model described in the dialog scenario in the above-stated example. In the state transition model of FIG. 4, in the state S1, the dialog system asks about age (question 1). If the answer of a user in response to this question is “teens”, the state is changed to the state S2. If the answer is “twenties”, the state is changed to the state S3, and if the answer is “thirties”, the state is changed to the state S4. Then, in the state S3, the dialog system asks about sex (question 2). If the answer of the user in response to this question is “male”, then the state is changed to the state S5, and if the answer is “female”, then the state is changed to the state S6. Herein, in the state S3, if the user reinputs an answer in response to the question 1, then based on the answer reinput, the state is changed to the same state as in the user answering in the same way in the state S1.

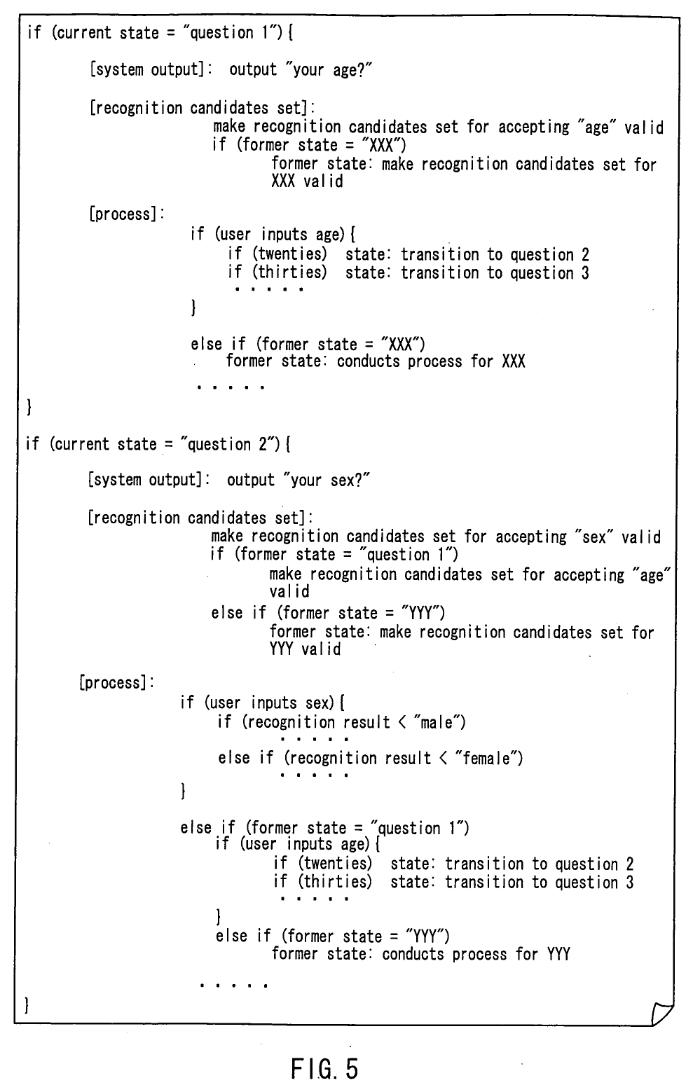

In order to realize such a state transition model, that is, in order to enable the acceptance of reinput for the answer to the first question 1 (about age) even during the second question 2 (about sex), while enabling appropriate processing of these questions, the following is required in a conventional dialog system: in a dialog scenario, the recognition candidates set for accepting age is made valid, while a process to be conducted when an age is actually input has to be explicitly described in the dialog scenario (see FIG. 5). Especially in the case where the next transition state is varied based on the contents of a user's input as in this example, complicated processes have to be described for both of the state prior to the transition and the state after the transition. Further, as in the transition from the state S7 or S8 to the state S3 of FIG. 4, the dialog may include a flow of some question other than about age, followed by a question about sex. Therefore, the dialog scenario has to be described with consideration given to the flow of the entire dialog as to what the former question (state) is, so that the development cost for the dialog scenario is extremely expensive.

On the other hand, in the dialog system according to the present embodiment, similarly to Embodiment 1, the name of the state prior to the transition to the current state and the recognition candidates set assigned to the state prior to the transition to the current state are stored in the reinput acceptable state storage unit 109 and the reinput recognition candidates set storage unit 110, respectively. And the recognition processing unit 108 performs a recognition process by referring to both of the recognition candidates set assigned to the state prior to the transition to the current state and the recognition candidates set assigned to the current state. Further, the state management unit 102 determines the next transition state based on the current state stored in the current state storage unit 103 and the recognition result by the recognition processing unit 108. Thereby, in the case of reinput by a user, processes can be appropriately conducted without a dialog scenario described on the assumption of the reinput by the user.

FIG. 6 is a dialog scenario used in the dialog system of the present embodiment. As can be seen from the comparison between FIGS. 5 and 6, the dialog scenario used in the dialog system of the present embodiment is a lot simpler than the dialog scenario used in a conventional dialog system of FIG. 5.

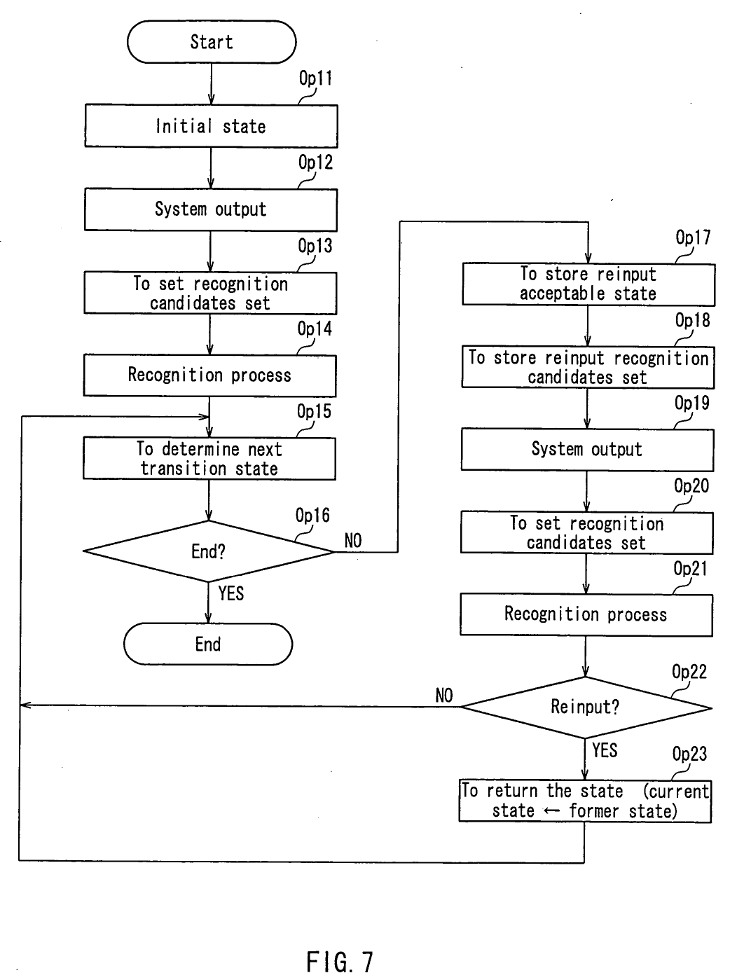

FIG. 7 is a flowchart showing the flow of the procedure in the dialog system according to the present embodiment. Firstly, the procedure starts from the state described as an initial state in the dialog scenario (Op11). The process execution unit 104 executes a process assigned to the state described as the initial state. More specifically, firstly, the output unit 106 performs system output (questions from the system to a user and the like) assigned to that state in the dialog scenario (Op12). Next, among the recognition candidates sets stored in the recognition candidates set storage unit 107, the recognition candidates set assigned to the current state is made valid (Op13). Then, when the user performs inputting in response to the system output, the recognition processing unit 108 performs a recognition process by comparing the user's input with the recognition candidates set made valid at Op13 under the control of the process execution unit 104 (Op14). Then, based on the result of the recognition process at Op14, the state management unit 102 determines the next transition state among the states included in the state transition model (Op15).

If the next transition state determined at Op15 is the end state (YES at Op16), the state management unit 102 finishes the dialog. On the other hand, if the next transition state determined at Op15 is not the end state (No at Op16), the state management unit 102 makes the reinput acceptable state storage unit 109 store the name of the state prior to the transition (Op17). Further, the state management unit 102 makes the reinput recognition candidates set storage unit 110 store the recognition candidates set assigned to the state prior to the transition (Op18).

Thereafter, the process execution unit 104 executes the process assigned to the transition state determined at Op15, whereby the system output (questions from the system to the user and the like) assigned to that state in the dialog scenario is performed from the output unit 106 (Op19). That is, at this time, the state is changed from the initial state at Op11 to the state determined at Op15. Next, the recognition processing unit 108 makes both of the recognition candidates set assigned to the current state i.e., the state after the transition) and the recognition candidates set stored in the reinput recognition candidates set storage unit 110 valid (Op20), and compares the user's input with these recognition candidates sets, whereby a recognition process of the user's input is performed (Op21). In the case where a recognition result of the user's input is obtained, the reinput judgment unit 111 judges whether the user's input is reinput or not (Op22). The way of judging by the reinput judgment unit 111 at Op22 will be described later.

At Op22, in the case where it is judged that the user's input is not reinput, the procedure returns to Op15, where the state management unit 102 determines the next transition state. On the other hand, in the case where it is judged that the user's input is reinput, the current state is changed to the state stored in the reinput acceptable state storage unit 109 (i.e., the immediately preceding state) (Op23), and then the procedure returns to Op15.

At the above Op22, the reinput judgment unit 111 judges whether the user's input is reinput or not, based on the fact that the user's input matches any one of the recognition candidates included in the recognition candidates set assigned to the current state or in the recognition candidates set assigned to the former state (the recognition candidates set stored in the reinput recognition candidates set storage unit 110). In the case where the user's input matches any one of the recognition candidates included in both of the recognition candidates set assigned to the former state and the recognition candidates set assigned to the current state, the priorities may be determined by comparing their reliabilities that are returned with the recognition results. Further, weights may be assigned to the reliabilities based on the possibility of the reinput. If the user's input matches any one of the recognition candidates commonly included in the recognition candidates set assigned to the former state and the recognition candidates set assigned to the current state (e.g., in the dialog scenario, in the case where the father's age is asked in some state, and the mother's age is asked in the subsequent state), it may be judged that the user's input matches the recognition candidate included in the recognition candidates set assigned to the current state (i.e., this is not reinput).

### Embodiment 3

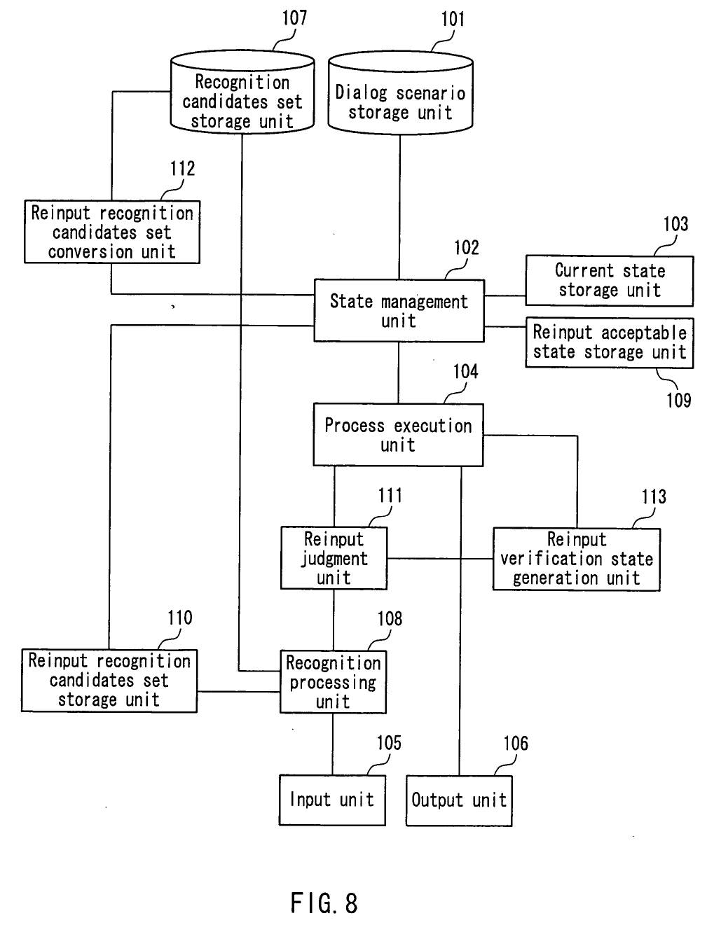

The following describes still another embodiment of a dialog system according to the present invention. FIG. 8 is a block diagram schematically showing the configuration of a dialog system according to the present embodiment. Note here that the same reference numerals are assigned to the elements having the same functions as those in the configuration described in the above-stated embodiments, and their detailed explanations are omitted.

As shown in FIG. 8, the dialog system of the present embodiment includes a unit 112 for converting a recognition candidates set for reinput (hereinafter called “reinput recognition candidates set conversion unit 112) and a reinput verification state generation unit 113, in addition to the configuration of the dialog system according to Embodiment 2. The reinput recognition candidates set conversion unit 112 converts a recognition candidates set assigned to the former state to a recognition candidates set that facilitates reinput by a user in order to enhance the recognition performance during the reinput. When the user's input is judged as reinput as a result of the recognition, the reinput verification state generation unit 113 generates a state of carrying out a dialog for explicitly verifying with the user the recognition result of the reinput.

When a user reinputs an answer, the reinput often involves vocabulary items expressing negation such as “No, . . . ”, emphasis such as “ . . . I said . . . ” and changes such as “No . . . ” depending on the situation. Therefore, the reinput recognition candidates set conversion unit 112 adds recognition candidate including such items specific to the reinput added at before and/or after the recognition candidate registered and described in the recognition candidates set assigned to the former state as new recognition candidate. If a user reinputs an answer because of a recognition error, the past recognition result may be removed from the recognition candidates set assigned to the former state, which can prevent the repetition of the same recognition error.

Further, in the case of the transition from some state to the next state with no answers from a user, the reinput acceptable state storage unit 109 and the reinput recognition candidates set storage unit 110 are not updated, whereby the user can perform reinput for the former state in a further forward state. Further, in the case where a possibility of reinput is low after a certain period of time has elapsed from the first answer, it can be determined whether the recognition candidates set stored in the reinput recognition candidates set storage unit 110 should be made valid or not, based on the elapsed time.

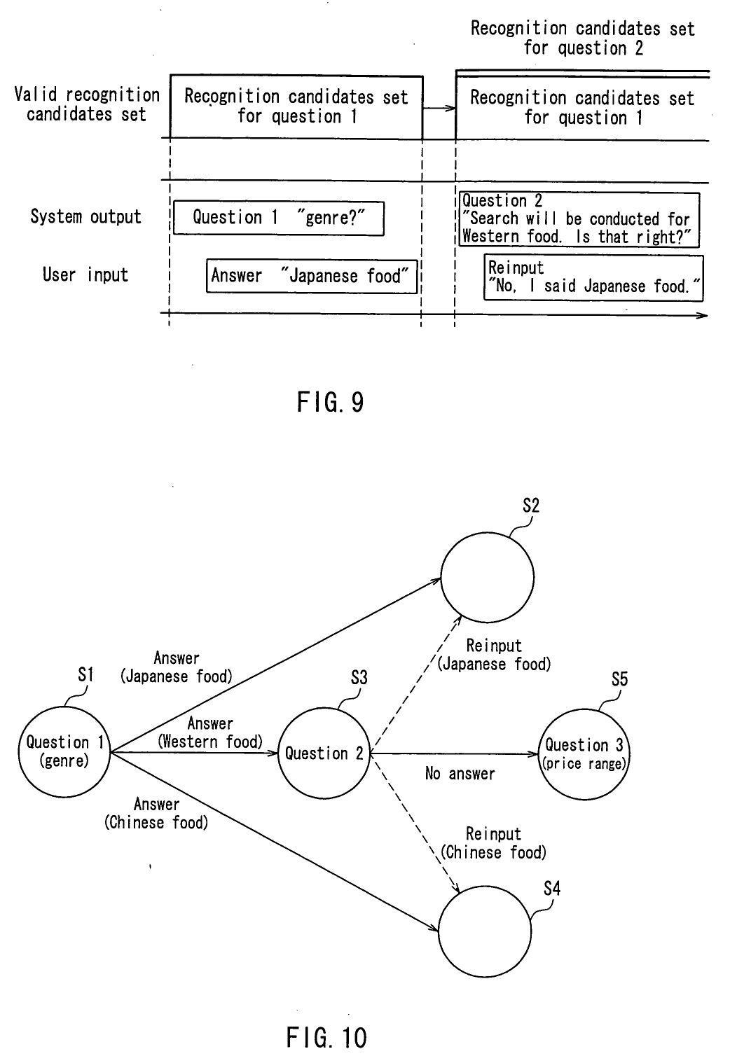

The following describes an operation of the dialog system according to the present embodiment. In the following, a dialog scenario is assumed as one example in which a user inputs some conditions for accessing restaurant searching service. FIG. 9 shows a dialog example in which when the dialog system firstly asks a genre of food that the user wishes (question 1), although the user answers “Japanese food”, the system erroneously recognizes it as “Western food”, and thereafter during the verification by the system for the searching conditions (question 2), the user inputs an answer of “No, I said Japanese food.” again as reinput for question 1.

FIG. 10 shows a state transition model described in the dialog scenario of the present embodiment. As shown in FIG. 10, in this dialog scenario, depending on the recognition results (“Japanese food”, “Western food” and “Chinese food”) of a user's input in response to a question about genre of food (question 1) in the first state (S1), the state is changed to mutually different states (S2 to S4). Further, in the state S3, during the verification by the dialog system for the searching conditions (question 2), if these is no input from the user, then the state is changed to the next state (S5).

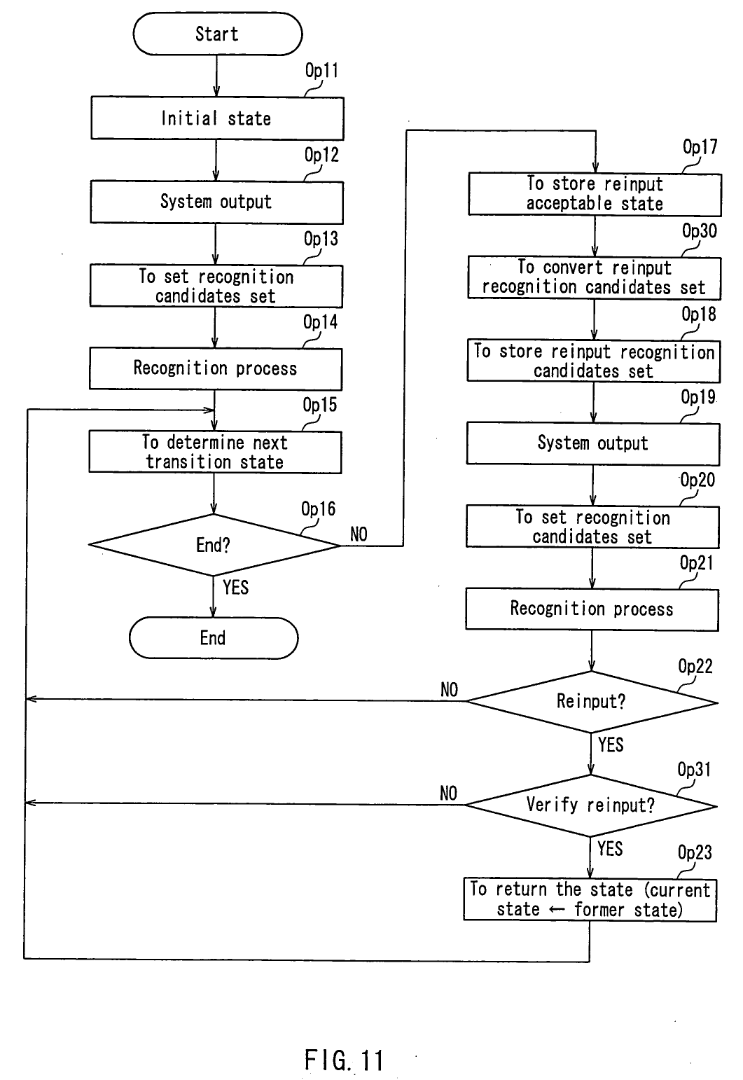

FIG. 11 is a flowchart showing the flow of the procedure in the dialog system according to the present embodiment. Note here that the dialog system of the present embodiment includes procedures of Op30 and Op31 added after Op17 and Op22, respectively, of the procedure of the dialog system according to Embodiment 2 of FIG. 7. Since the procedure from Op11 to Op23 is the same as that of Embodiment 2, the explanation therefor is omitted.

At Op30, the reinput recognition candidates set conversion unit 112 converts the recognition candidates set assigned to the former state, and makes the reinput recognition candidates set storage unit 110 store the converted recognition candidates set. As stated above, when a user reinputs an answer, the answer often involves vocabulary items specific to the reinput (accessory vocabulary items). Therefore, in order to accept such an answer, the reinput recognition candidates set conversion unit 112 adds recognition candidate including the vocabulary items specific to the reinput added at before and/or after the recognition candidate described in the recognition candidates set assigned to the former state as new recognition candidate, thus converting the recognition candidates set.

As the accessory vocabulary items specific to the reinput, vocabulary items expressing negation such as “No, . . . ” and “That's wrong, . . . ”, vocabulary items expressing emphasis such as “I said . . . ”, “I mean . . . ” and “You know . . . ” for correcting recognition errors, vocabulary items expressing changes such as “No, . . . ” for correcting the input can be considered. Note here that the accessory vocabulary items listed above are just illustrative examples and they are not limited to these examples. Further, in order to prevent the repetition of the same recognition error, the recognition candidates set can be converted so that the past recognition result (“Western food” in this case) is removed from the recognition candidates set.

At Op31, if the reinput judgment unit 111 judges that the recognition result of the user's input shows reinput, the dialog for explicitly verifying with the user the recognition result is provided prior to the process of the former state. This can be realized by making the process execution unit 104 execute the process assigned to the state generated by the reinput verification state generation unit 113. In this example, the user is asked explicitly for verification about the recognition result of the reinput as in “Japanese food, is that right?” This procedure can prevent, if it is judged erroneously that the user performs reinput although this is not the case, the input up to that time from being abandoned so that the state is changed to an unexpected one to the user.

In the dialog system according to the present embodiment, in the case where the state is changed to the next one without any input from a user, the processes of updating the state stored in the current state storage unit 103 and the recognition candidates set stored in the reinput recognition candidates set storage unit 110 (Op17 and Op18) are not conducted. Thereby, in this example, in the case where the user does not input any response to question 2 of “Search will be conducted for Western food. Is that right?” and even after the state is changed to the next one of S5 where a question like “What's your price range?” (question 3 of FIG. 10) is given, the user can perform reinput for food genre (question 1).

### Embodiment 4

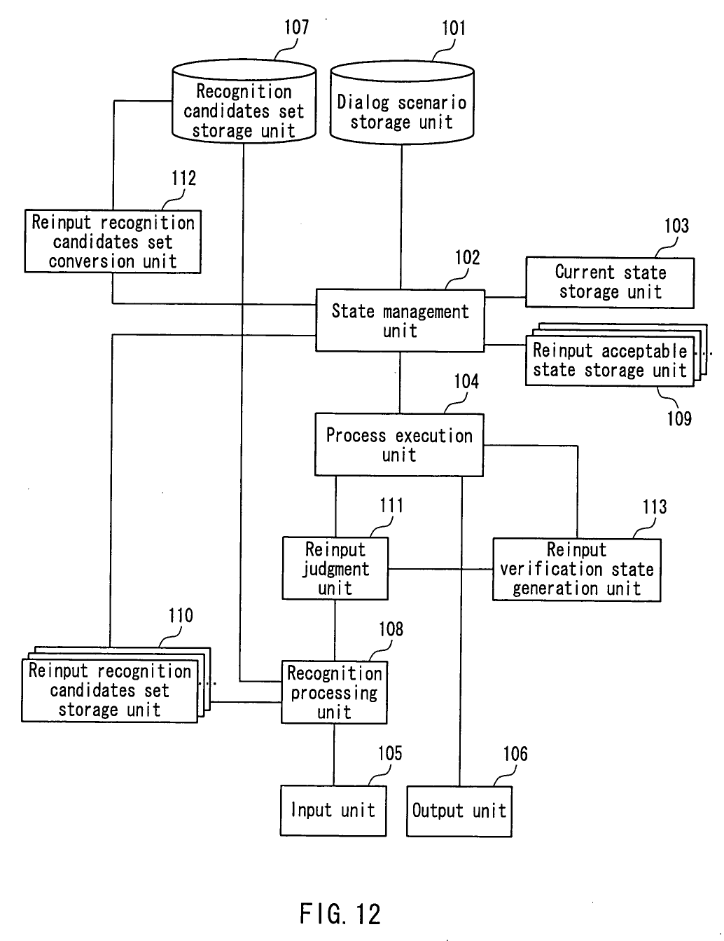

The following describes a further embodiment of a dialog system according to the present invention. FIG. 12 is a block diagram schematically showing the configuration of a dialog system according to the present embodiment. Note here that the same reference numerals are assigned to the elements having the same functions as those in the configuration described in the above-stated embodiments, and their detailed explanations are omitted.

As shown in FIG. 12, the dialog system of the present embodiment has the basic configuration similar to that of the dialog system according to Embodiment 3. However, the dialog system of the present embodiment further enables the acceptance of reinput not only for the immediately preceding state but also for a further preceding state. For this purpose, the reinput acceptable state storage unit 109 and the reinput recognition candidates set storage unit 110 respectively store a plurality of past states and the recognition candidates sets corresponding to the respective states.

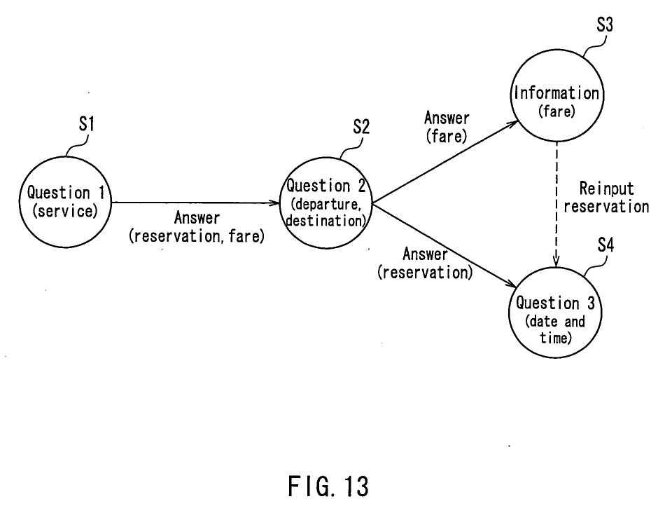

The following describes an operation of the dialog system according to the present embodiment. In the following, a dialog scenario is assumed for providing airfare inquiry service and reservation service. FIG. 13 shows a state transition model described in the dialog scenario in the dialog system of the present embodiment. In this dialog scenario, firstly, the user's intended service is asked (question 1) in the first state S1, and in the next state of S2, the departure and the destination are asked (question 2). The flow of the following dialog is varied depending on the service selected by the user in the state S1. That is, in the case where the user selects the “airfare” inquiry service in the state S1, the state is changed from S2 to S3 so as to show information on the airfare. On the other hand, in the case where the user selects the “reservation” service in the state S2, the state is changed from S2 to S4 to ask about the date and time (question 3).

In such a state transition model, in order to enable the acceptance of not only the reinput for the immediately preceding question but also the reinput for a further preceding question, the reinput acceptable state storage unit 109 and the reinput recognition candidates set storage unit 110 respectively store a plurality of states and the recognition candidates set corresponding to the respective states. Then, when the state is changed, the state prior to the transition and the recognition candidates set assigned to the state prior to the transition are additionally stored in the reinput acceptable state storage unit 109 and the reinput recognition candidates set storage unit 110, respectively. Then, during the recognition process, all of the recognition candidates sets stored in the reinput recognition candidates set storage unit 110 are made valid concurrently with the recognition candidates state assigned to the current state. In the case where reinput is performed for a past question, after the current state is changed to the state among the states stored in the reinput acceptable state storage unit 109, to which the recognition candidates set containing a recognition candidate matching the user's input is assigned, the next transition state is determined.

For instance, in the state transition model of FIG. 13, if the user inputs “reservation” during the time when the information on airfare is provided (state S3), the recognition processing unit 108 recognizes that a recognition candidate included in the recognition candidate set corresponding to the state S1 is input. Thereby, the user is permitted to change his/her intended service from the “airfare” inquiry to the “reservation” partway through the dialog. In this case, since the reinput for the state S1 is accepted, when the state is subsequently changed to S2, questions about the departure and the destination are provided again.

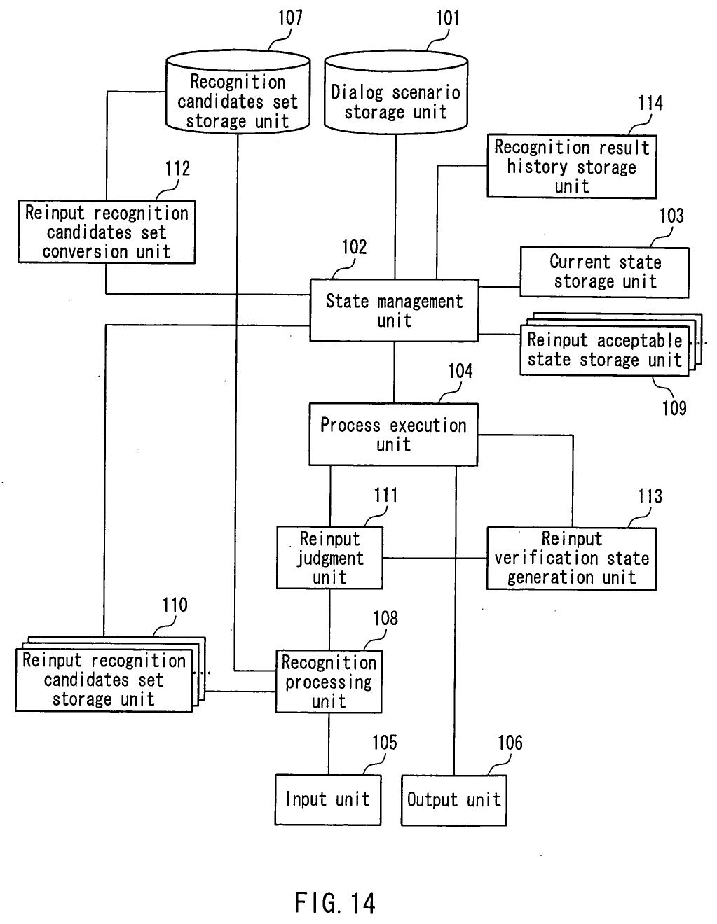

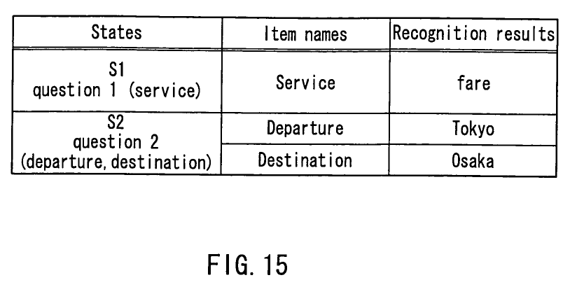

As a further improved example of the present embodiment, as shown in FIG. 14, a recognition result history storage unit 114 may be further added so that a state can be skipped if its recognition result has been already obtained. FIG. 15 shows schematically one example of the contents stored in the recognition result history storage unit 114. In the example of FIG. 15, the recognition result of the user's input for the state S1 of FIG. 13 is “airfare” and the recognition results of the user's inputs for the state S2 are “Tokyo” for the departure and “Osaka” for the destination. In the case where the contents of FIG. 15 are stored in the recognition result history storage unit 114, if the user inputs “reservation” during the time when the information on airfare is provided in the state S3, the state management unit 102 refers to the contents stored in the recognition result history storage unit 114 so as to confirm that the recognition results of the user's inputs for the states S1 and S2 have been already obtained, and skips the state S2 and changes the state to S4. Therefore, the user does not need to input the departure and the destination again in the state S2 during the procedure for the airfare inquiry service.

With respect to the reinput should be made acceptable to a question at what time point in the past, whether or not to make each of the recognition candidates sets stored in the reinput recognition candidates set storage unit 110 valid may be determined based on the elapsed time after each recognition candidates set is stored. Alternatively, with respect to the recognition candidates set in how many preceding state should be made valid, this can be determined based on the state transition number until that time. Further, at the time when a predetermined task (e.g. the reservation of an airline ticket) has been completed, the contents of the reinput acceptable state storage unit 109 and the reinput recognition candidates set storage unit 110 may be cleared.

Note here that when a user' input matches the recognition candidate included in the recognition candidates set stored in the reinput recognition candidates set storage unit 110, the state execution unit 104 may call a procedure for restoring the result of the procedure of an external application called at the current state to an original state. For instance, in the process assigned to some state, both of the procedure for calling an application program and the procedure for restoring the processing result by the application program to an original state can be set at a call ready state. Herein, the procedure for restoring the procedure result to an original state does not always require the description in a dialog scenario, and in the case where a user's input is judged as the reinput, this procedure can be carried out automatically irrespective of the dialog scenario.

For instance, in the case of a dialog system operating associated with a database, it is assumed that an application program for writing to the database is called so as to start a writing procedure to the database. Thereafter, when the user performs reinput, API for canceling the writing to the database is called, whereby an influence of the former user's input can be cancelled.

The present invention is applicable to a dialog system having a high usability that permits reinput by a user without describing a code for processing the reinput in a dialog scenario.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A dialog system, comprising:
an input unit that accepts an input by a user;
an output unit that presents information to the user;
a dialog scenario storage unit that stores a dialog scenario with a state transition model described therein that is in accordance with a dialog with the user performed through the input unit and the output unit;
a state management unit that, based on the state transition model described in the dialog scenario, determines a state to be changed next among states included in the state transition model in accordance with the input by the user through the input unit;
a current state storage unit that stores a current state among the states included in the state transition model;
a process execution unit that executes a process assigned to the state determined by the state management unit;
a recognition candidates set storage unit that stores beforehand recognition candidates sets including recognition candidates for user's inputs that are assumed with respect to each of states included in the state transition model, each of the recognition candidates sets being associated with each of the states included in the state transition model;
a reinput acceptable state storage unit that, at the time of transition to a next state, stores a state prior to the transition;
a reinput recognition candidates set storage unit that, at the time of the transition to the next state, stores a recognition candidates set assigned to the state prior to the transition; and
a recognition processing unit that, at the time of a user's input, refers to both of the recognition candidates set associated with a state at the time of the user's input and the recognition candidates set stored in the reinput recognition candidates set storage unit so as to determine a recognition candidate corresponding to the user's input,
wherein in the case where the recognition candidate determined by the recognition processing unit is a recognition candidate described in the recognition candidates set stored in the reinput recognition candidates set storage unit, the state management unit determines that the state stored in the reinput acceptable state storage unit is the state to be changed.

2. The dialog system according to claim 1, further comprising a reinput judgment unit,
wherein, at the time of a user's input, in the case where both of the recognition candidates set associated with the state stored at that time in the current state storage unit and the recognition candidates set stored in the reinput recognition candidates set storage unit include a recognition candidate corresponding to the user's input, the reinput judgment unit determines a priority order of these recognition candidates sets based on a predetermined criterion.

3. The dialog system according to claim 1, further comprising a reinput recognition candidates set conversion unit that converts the recognition candidates set stored in the reinput recognition candidates set storage unit to a recognition candidates set including recognition candidates that are assumed to be used when the user performs reinput.

4. The dialog system according to claim 3,
wherein the recognition processing unit further stores a result of preceding recognition, and
the reinput recognition candidates set conversion unit removes the result of the preceding recognition from the recognition candidates set stored in the reinput recognition candidates set storage unit.

5. The dialog system according to claim 3,
wherein the reinput recognition candidates set conversion unit adds, to the recognition candidates set stored in the reinput recognition candidates set storage unit, new recognition candidates obtained by adding vocabulary items that are used by the user during reinput to any one of recognition candidates described in the recognition candidates set.

6. The dialog system according to claim 1,
wherein in the case where some state is changed to a next state without any inputs from the user, the state stored in the reinput acceptable state storage unit and the recognition candidates set stored in the reinput recognition candidates set storage unit are not updated.

7. The dialog system according to claim 1, further comprising a reinput result verification state generation unit that, in the case where an input by the user matches a recognition candidate included in the recognition candidates set stored in the reinput recognition candidates set storage unit, generates a state for explicitly verifying with the user a recognition result of the recognition processing unit.

8. The dialog system according to claim 1,
wherein in the case where an input by the user matches a recognition candidate included in the recognition candidates set stored in the reinput recognition candidates set storage unit, a procedure is called that is for restoring a result of a procedure by an application program called at a state of the input by the user to an original state.

9. The dialog system according to claim 1,
wherein the reinput acceptable state storage unit comprises a region for storing a plurality of past states, and
the reinput recognition candidates set storage unit comprises a region for storing recognition candidates sets assigned to the past states,
wherein the dialog system further comprises a recognition result history storage unit that stores a recognition result obtained in response to a user's input to a past state.

10. A recording medium having thereon a program that makes a computer execute a dialog process with a user, wherein the computer is provided with an input unit accepting an input by the user and an output unit presenting information to the user, the program making the computer execute the steps of:
a process execution step of referring to a dialog scenario with a state transition model described therein that is in accordance with a dialog with the user performed through the input unit and the output unit, determining, based on the state transition model, a state to be changed next among states included in the state transition model in accordance with the input by the user through the input unit, and storing the determined state in a current state storage unit and executing a process assigned to the determined state;
a storage step of, at the time of transition to a next state, storing a state prior to the transition in a reinput acceptable state storage unit and storing a recognition candidates set assigned to the state prior to the transition in a reinput recognition candidates set storage unit; and
a recognition step of, at the time of a user's input, referring to a recognition candidates set storage unit that stores beforehand recognition candidates sets including recognition candidates for user's inputs that are assumed with respect to each of states included in the state transition model, each of the recognition candidates sets being associated with each of the states included in the state transition model, and referring to both of the recognition candidates set associated with a state at the time of the user's input and the recognition candidates set stored in the reinput recognition candidates set storage unit so as to determine a recognition candidate corresponding to the user's input,
wherein in the case where the recognition candidate determined at the recognition step is a recognition candidate described in the recognition candidates set stored in the reinput recognition candidates set storage unit, in the subsequent process execution step, the program makes the computer determine that the state stored in the reinput acceptable state storage unit is the state to be changed.

11. A dialog processing method by a computer provided with an input unit accepting an input by a user and an output unit presenting information to the user, comprising the steps of:
a process execution step of referring to a dialog scenario with a state transition model described therein that is in accordance with a dialog with the user performed through the input unit and the output unit, determining, based on the state transition model, a state to be changed next among states included in the state transition model in accordance with the input by the user through the input unit, and storing the determined state in a current state storage unit and executing a process assigned to the determined state;
a storage step of, at the time of transition to a next state, storing a state prior to the transition in a reinput acceptable state storage unit and storing a recognition candidates set assigned to the state prior to the transition in a reinput recognition candidates set storage unit; and
a recognition step of, at the time of a user's input, referring to a recognition candidates set storage unit that stores beforehand recognition candidates sets including recognition candidates for user's inputs that are assumed with respect to each of states included in the state transition model, each of the recognition candidates sets being associated with each of the states included in the state transition model, and referring to both of the recognition candidates set associated with a state at the time of the user's input and the recognition candidates set stored in the reinput recognition candidates set storage unit so as to determine a recognition candidate corresponding to the user's input,
wherein in the case where the recognition candidate determined at the recognition step is a recognition candidate described in the recognition candidates set stored in the reinput recognition candidates set storage unit, in the subsequent process execution step, the state stored in the reinput acceptable state storage unit is determined as the state to be changed.
